(19) United States
(12) Patent Application Publication
(10) Pub. No.: US 2012/0218464 A1
(43) Pub. Date: Aug. 30, 2012

(54) Method and system for structured light 3D camera

(76) Inventors: Sagi Ben-Moshe, Kiryat Bialik (IL); Ron Kimmel, Haifa (IL); Michael Bronstein, Ticino (CH)

(21) Appl. No.: 13/337,327

(22) Filed: Dec. 27, 2011

Related U.S. Application Data
(60) Provisional application No. 61/427,497, filed on Dec. 28, 2010.

(51) Int. Cl. H04N 5/238; G02B 26/08

(52) U.S. Cl. 348/369; 359/225.1; 348/E05.04

(57) ABSTRACT

An apparatus and system for projecting coded light and for imaging thereof, featuring a micro-mirror for pivoting and for causing each of a plurality of masks to be illuminated sequentially, each mask having a different pattern.

This Application claims priority from U.S. Provisional Application No. 61/427,497, filed 28 Dec. 2010, which is hereby incorporated by reference as if fully set forth herein.

### FIELD OF THE INVENTION

The present invention relates to a time-multiplexed structured (coded) light camera, in which the light patterns are formed by means of a micro-mirror illuminating a mask, which may optionally comprise an array of diffraction elements.

### BACKGROUND OF THE INVENTION

Coded light is a method for 3D geometry acquisition, in which the object of interest is illuminated by a time-multiplexed sequence of patterns, e.g., horizontal or vertical stripes of varying width, forming a binary or Gray code. Using a camera calibrated with the projecting system, the 3D geometry is recovered by triangulation (the code allows to establish correspondence between the camera and the projector coordinate systems in each pixel).

A critical element of a coded light camera is the projection system capable of illuminating the object with a rapidly changing sequence of patterns. Typically, 3-14 patterns are required to reconstruct a 3D image with sufficiently high resolution; hence, in order to acquire 30 depth frames/second (fps), the projector must be able to project the patterns at a sufficiently rapid rate (typically, 90-420 fps).

Current available designs of coded light systems use standard computer-controlled projectors, based on LCD, ELCOS, or DMD (digital micro-mirror device) micro-mirror arrays of Texas Instruments° illuminated by a LED light source.

The DMD of Texas Instruments° is an optical MEMS (micro-electronic mechanical system) device, composed of several hundred thousand microscopic mirrors arranged in a rectangular array on its surface, which are individually addressable and tiltable through control by underlying CMOS (complementary metal-oxide-semiconductor) electronics.

In operation, for example for use in a coded light projection system, the DMD is also a spatial light modulator (SLM) device. As such, although the device itself is quite complicated and expensive, operationally the underlying algorithms are relatively straightforward. Each micro-mirror is individually controllable, permitting any desired sequence of patterns to be easily created and projected. Unfortunately, its expense renders the use of the DMD, and other similar systems, much less practical for coded light projection systems.

### SUMMARY OF SOME EMBODIMENTS OF THE INVENTION

The background art does not teach or suggest a system or method for a coded light projection system which is fast and accurate, yet inexpensive.

The present invention overcomes these drawbacks of the background art by providing a system or method for a coded light projection system which is fast and accurate, yet inexpensive, through the provision of suitable patterns by a plurality of masks, illuminated with a light beam that is reflected by a pivoting mirror, which is preferably a single pivoting minor but may optionally be two such pivoting mirrors. The plurality of masks may for example optionally comprise any array of diffractive elements. Each mask corresponds to a pattern to be projected. The masks are illuminated sequentially at the desired frame rate through rotation of the mirror and hence reflection of the light beam; for example, for a frame rate of 300 fps, the masks need to be illuminated sequentially at 300 Hz to produce the desired sequence of patterns. Overall, the obtained frame rate is determined from the number of mask patterns per cycle times number of Hz (scanning rate of the mirror) and preferably ranges from 10 fps to 1000 fps. As an example, A mirror operating at a scanning rate of X Hz and toggling (selecting) between Y patterns would project patterns at a rate of X*Y Hz. For example, a mirror scanning rate of 40 Hz for toggling between 10 patterns would yield patterns projected at a rate of 400 fps (i.e. 400 Hz). The mask array can be one dimensional (vector) or two dimensional (matrix).

According to at least some embodiments, the mask produces a structured light pattern (e.g. horizontal or vertical stripes). In one embodiment of the invention, amplitude masks are used. An amplitude mask is combination of transparent (e.g. glass or plastic) and partially transparent or fully non-transparent material (e.g. metal coating) that when illuminated by the light beam partially or fully blocks the light at partially or fully transparent regions of the mask and passes the light at transparent parts of the mask. The functional principle of such a system is similar to a slide projector where the slide acts as an amplitude mask.

In another embodiment of the invention, a diffraction optical element (DOR) is used as the mask. Diffraction optics is based on the fact that light exhibits wave properties when interacting with objects at the scale of its wavelength. Typically, diffraction phenomena are observed when coherent light (laser) passes through a grating. By designing the grating, it is possible to control the resulting diffraction pattern, and thus create an image of the desired structure light pattern.

The mask can be coupled with other optical elements as is known in the art of optical system design. In one embodiment of the invention, the mask is one-dimensional, and is coupled with optical elements such as cylindrical lens or non-uniform diffuser that creates a two-dimensional image out of a one-dimensional profile. For example, in order to create a pattern of vertical stripes, a one-dimensional horizontal profile (line) of the stripes is created by illuminating a one-dimensional mask, and then a lens or diffuser is used to open the one-dimensional profile in the vertical direction into a two-dimensional image.

Preferably, the mirror is characterized as a micro-mirror, in that the size of the mirror is microscopic. Preferred mirror sizes may optionally be, for example, from about 1 micro-meters to about 5 mm across (by comparison, for the DMD, each micro-mirror is about 16 micro-meters across). The mirror may optionally be made of any suitable material, such as aluminum, gold or silicon for example.

Typically, such a micro-mirror is held in a frame that forms a gimbal structure, for micro-mirror devices that are known as “mirror-in-frame” devices. The mirror is able to pivot due to one or more pivots, which permit the mirror to pivot about one or more axes, respectively. The pivots may include torsional springs that provide a restoring force for the mirror plate in a desired position. The position of the mirror is determined by the angle of the mirror within the frame and the angle of the frame with respect to the support of the gimbaled structure. The term “position detection of the mirror” may also include position detection of both mirror and frame where appropriate. The mirror and frame may include one or more thin electrode(s) on its surface. Typically, one electrode will be present on each side of a pivot, so for example for two pivots (for permitting pivoting about two axes), there will be four electrodes in total. Each electrode is paired with a second electrode on a substrate; the presence of a charge between each pair of electrodes causes the mirror to pivot accordingly, through activation of electrostatic, electromagnetic, piezoelectric actuation, stepper motors, or thermal bimorphs. A pivot spring is typically used to urge the mirror back to a resting position once the charge is discontinued. Of course, this is only intended as a non-limiting example of a micro-mirror device; many such devices are known in the art and could easily be implemented by one of ordinary skill in the art.

The control of an array of many such micro-minors is well known in the art. Such control typically involves two aspects: initiation of movement of the micro-mirrors (i.e. —control of micro-mirror actuation); and feedback to determine whether any correction to such movement is required. Some non-limiting examples of feedback systems which are known in the art for applicability to micro-mirror control include optical feedback control, the addition of piezoresistive deflection sensors to the suspension pivot beams of the inner mirror and the outer frame, in which the output of the angle sensors is a measure of deflection around the two axes of rotation and is used to control the servo mechanisms that control the angle of deflection of the mirror; and sliding mode control, as described for example in U.S. Pat. No. 6,958,850, which is hereby incorporated by reference as if fully set forth herein. Non-limiting examples of optical feedback control include a system in which the mirror is controlled by maximizing the optical power of a collimated optical beam reflected from the minor and received in an optical fiber with photo tabs; and systems using a Position Sensing Detector (PSD) or a CCD (charge-coupled device) camera to detect the position of a light beam reflected from the mirror.

Any suitable control system as is known in the art may optionally be used in order to cause the minor to be located at a suitable position such that the light beam sequentially illuminates each mask in an array of masks. The masks themselves preferably do not move. The above examples of micro-mirrors and their control are given for the purposes of illustration only and are not intended to be limiting in any way.

### BRIEF DESCRIPTION OF THE DRAWINGS

FIGS. 1A and 1B show highly schematic diagrams of a micro-minor projector according to at least some embodiments of the present invention;

FIG. 2 shows two non-limiting, exemplary illustrative schematic block diagrams of a micro-mirror projector according to at least some embodiments of the present invention;

FIG. 3 shows a sequence of different patterns created by a motion of micro-mirror 102;

FIG. 4 shows an exemplary, non-limiting embodiment of an imaging system;

FIG. 5 shows a schematic diagram of an illustrative, exemplary imaging system;

FIGS. 6A-6C and FIG. 7 show the effects of sequentially illuminating a plurality of elements of the diffraction optical element array; and

FIG. 8 relates to an exemplary method according to at least some embodiments of the present invention for performing a process with a system such as that described in FIG. 4 for example.

### DESCRIPTION OF SOME EMBODIMENTS OF THE INVENTION

At least some embodiments of the present invention are now described with regard to the following illustrations and accompany description, which are not intended to be limiting in any way.

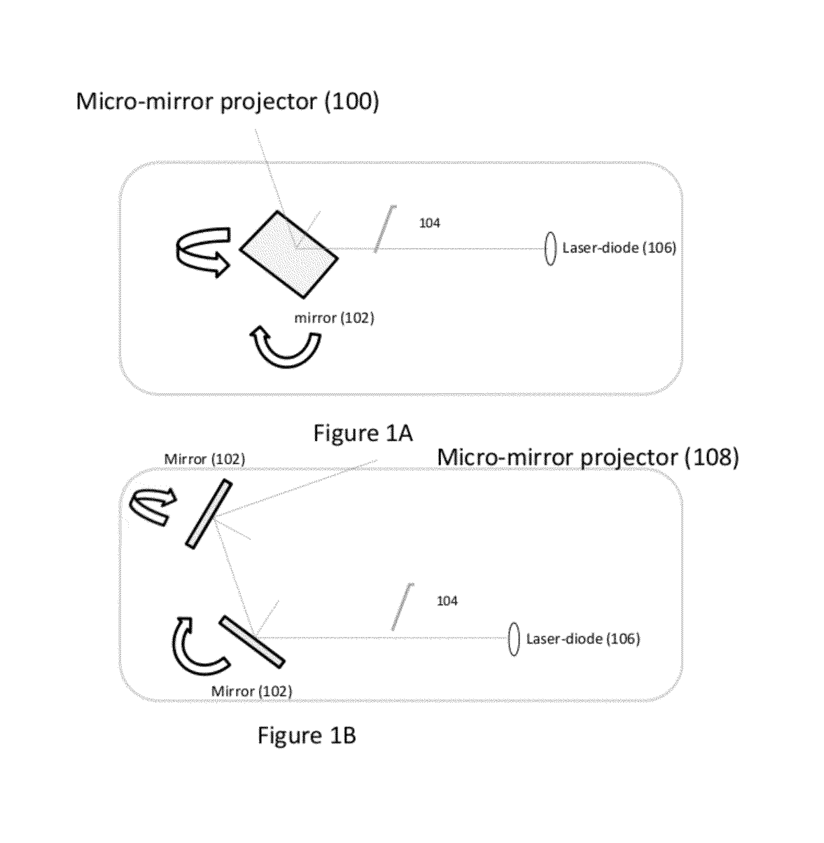

Referring now to the drawings, FIGS. 1A and 1B show highly schematic diagrams of a micro-mirror projector according to at least some embodiments of the present invention. As shown in FIG. 1A, a micro-mirror projector 100 features a micro-mirror 102 which is capable of pivoting about two axes as shown by the arrows. As previously described, micro-mirror 102 may optionally be pivoted about two axes by the presence of two pivots. As micro-mirror 102 pivots, a laser beam 104 from a laser diode 106 is reflected in various directions as shown, as a non-limiting example of a light beam from a light source (although the description centers around laser diodes as the light source, it is understood that optionally any suitable light source may be used).

FIG. 1B shows a different embodiment of a micro-mirror projector 108, which features two micro-mirrors 102 that are only capable of pivoting about one axis each, as shown by the arrows. Other components having the same or similar function as in FIG. 1A have the same numbering.

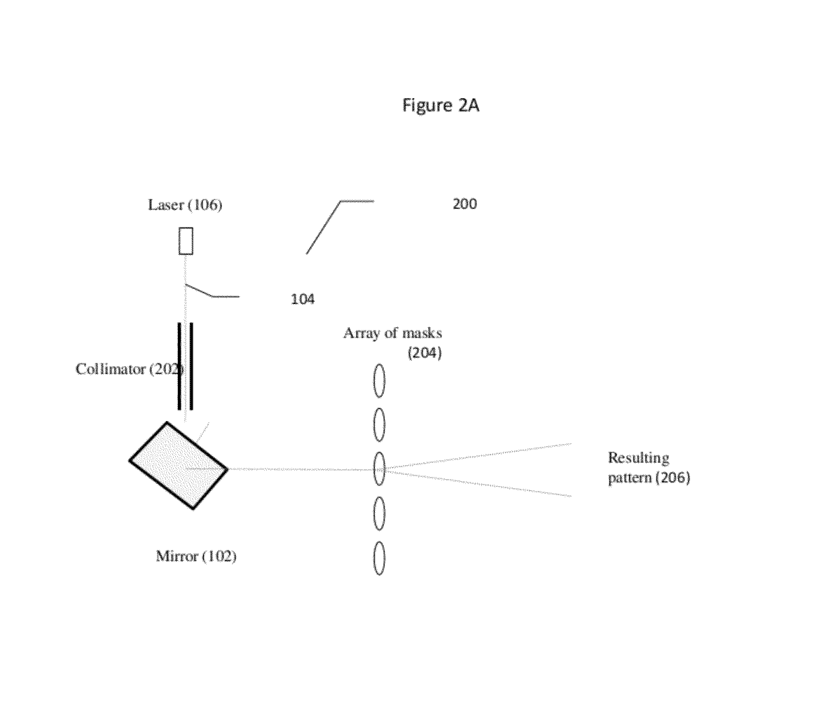

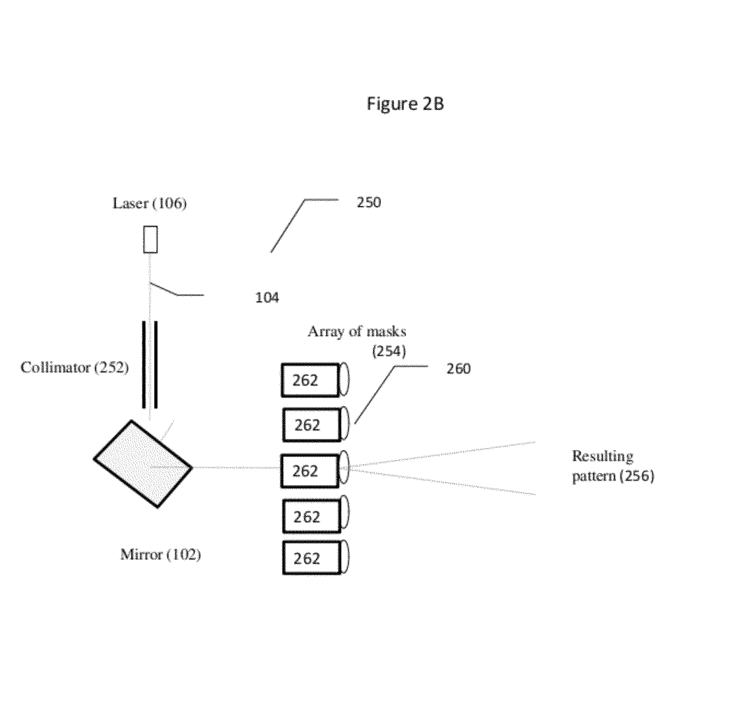

The array of masks is not shown in FIGS. 1A and 1B, but is illustrated in FIGS. 2A and 2B.

FIG. 2 shows two non-limiting, exemplary illustrative schematic block diagrams of a micro-mirror projector according to at least some embodiments of the present invention. In the embodiment of FIG. 2A, a first mask configuration is shown; in the embodiment of FIG. 2B, a second mask configuration is shown; both of which are non-limiting examples.

FIG. 2A shows a schematic diagram of a micro-minor projector 200 according to at least some embodiments of the present invention. As shown, micro-mirror projector 200 features micro-mirror 102 of FIG. 1A that is capable of pivoting about two axes as previously described. As micro-mirror 102 pivots, a laser beam 104 from laser 106, collimated by a collimator 202 as shown, illuminates each mask of an array of masks 204 as shown. Such sequential illumination creates a pattern 206 of light in space and time as shown.

Laser beam 104 hits the array of masks 204 at a specific location, for a short period of time. Preferably, the masks of array of masks 204 and their relative location, and the calibration between laser beam 104 and micro-minor 102, is designed such that there is sufficient tolerance to permit laser beam 104 to hit the desired location such that the desired pattern is generated. Feedback systems for various types of micro-mirrors are known in the art and could be implemented herein, for example as previously described.

Each mask of mask array 204 preferably produces a structured light pattern (e.g. horizontal or vertical stripes). As an optional, non-limiting example, in one embodiment of the invention, mask array 204 comprises a plurality of amplitude masks. An amplitude mask is combination of transparent material (e.g. glass or plastic) and partially transparent or fully non-transparent material (e.g. metal coating) that when illuminated by a light beam, such as laser beam 104, partially or fully blocks the light at partially or fully transparent regions of the mask and passes the light at transparent parts of the mask. The functional principle of such a system is similar to a slide projector where the slide acts as an amplitude mask.

In another embodiment of the invention, each mask of mask array 204 may optionally comprise a diffraction optical element (DOE). Diffraction optics is based on the fact that light exhibits wave properties when interacting with objects at the scale of its wavelength. Typically, diffraction phenomena are observed when coherent light (laser) passes through a grating. By designing the grating, it is possible to control the resulting diffraction pattern, and thus create an image of the desired structure light pattern.

FIG. 2B shows another non-limiting embodiment, in which the mask is one-dimensional. As shown, a micro-mirror projector 250 features micro-mirror 102 of FIG. 1A that is capable of pivoting about two axes as previously described. As micro-mirror 102 pivots, a laser beam 104 from laser 106, collimated by a collimator 252 as shown, illuminates each mask 260 of an array of masks 254 as shown. Such sequential illumination creates a pattern 256 of light in space and time as shown.

However, each mask 260 is one-dimensional and so is constructed differently from the mask of mask array 204 of FIG. 2A. Mask 260 features an optical element 262 which creates a two-dimensional image out of a one-dimensional profile. Optical element 262 may optionally comprise any suitable optical device as is known in the art, including but not limited to a cylindrical lens or non-uniform diffuser. For example, in order to create a pattern of vertical stripes, a one-dimensional horizontal profile (line) of the stripes is created by illuminating one-dimensional mask 260, and then optical element 262, such as a lens or diffuser, is used to open the one-dimensional profile in the vertical direction into a two-dimensional image.

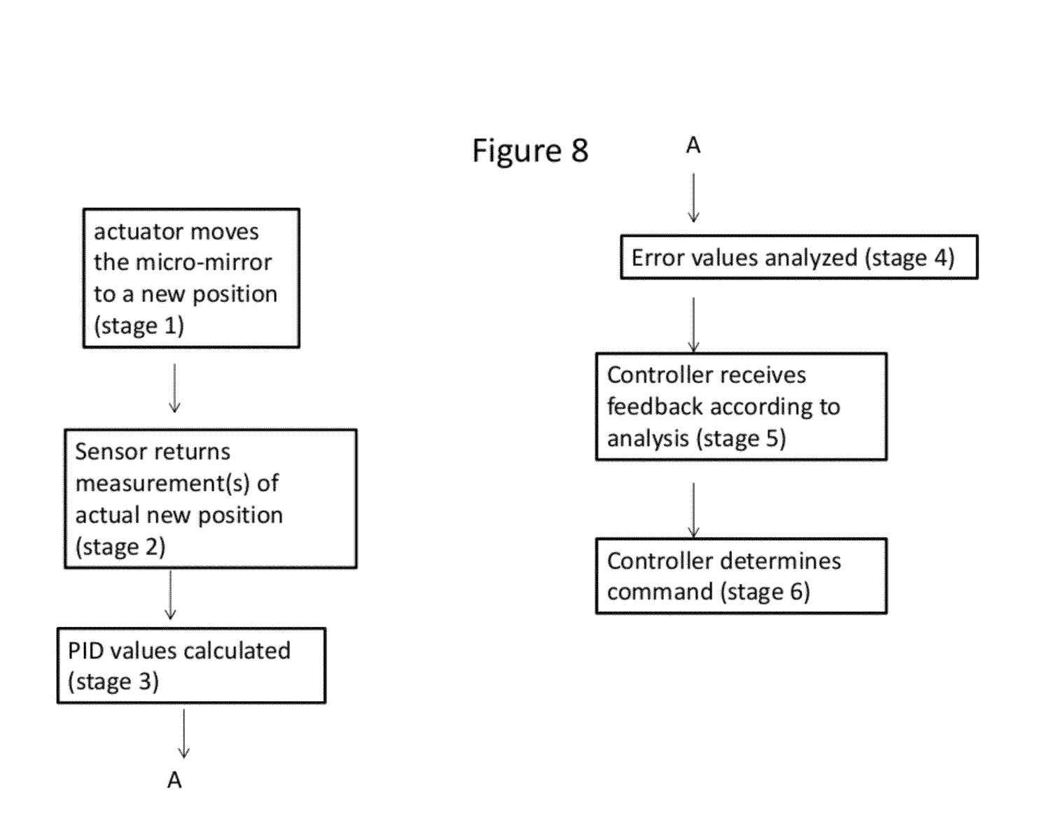

In operation, micro-mirror projector 250 functions similarly to that of FIG. 2A. Laser beam 104 hits the array of masks 254 at a specific location, for a short period of time. Preferably, the masks of array of masks 254 and their relative location, and the calibration between laser beam 104 and micro-mirror 102, is designed such that there is sufficient tolerance to permit laser beam 104 to hit the desired location such that the desired pattern is generated. Feedback systems for various types of micro-mirrors are known in the art and could be implemented herein, for example as previously described or as described with regard to the non-limiting exemplary method of FIG. 8 below.

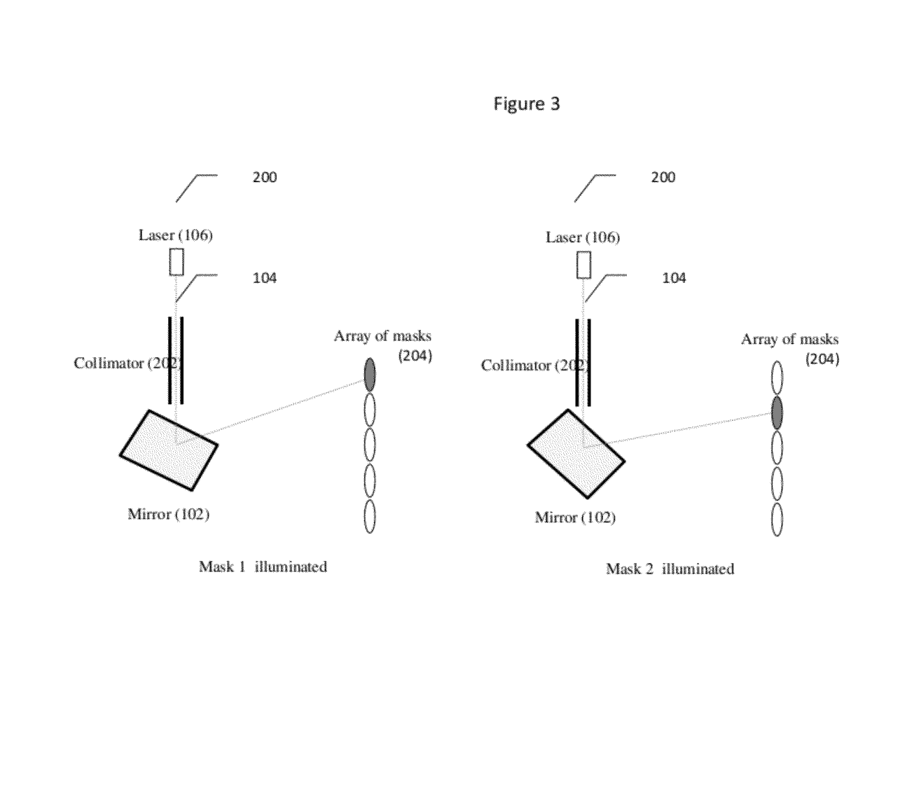

The motion of micro-mirror 102 creates a sequence of different patterns, as shown in FIG. 3. Components having the same or similar function as in FIG. 2A have the same numbering. As shown, on the left, mask 1 of mask array 204 is illuminated by laser beam 104 (mask 1 is indicated by shading). On the right, after micro-mirror 102 pivots, mask 2 of mask array 204 is illuminated by laser beam 104 (mask 2 is indicated by shading). Of course, a similar process could optionally be followed with the mask implementation of FIG. 2B.

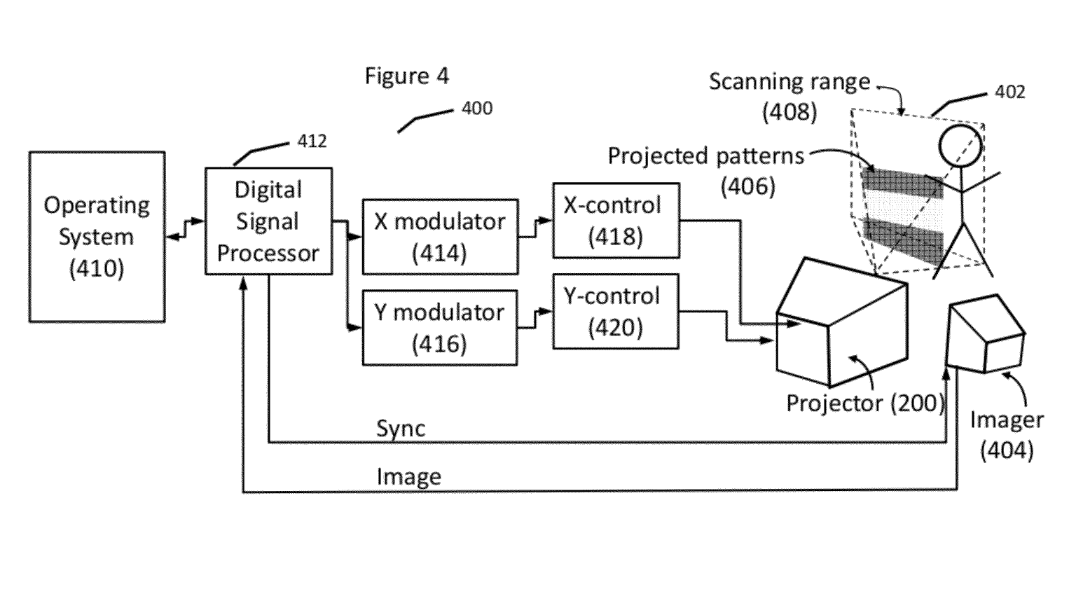

FIG. 4 shows an exemplary, non-limiting embodiment of an imaging system 400 according to at least some embodiments of the present invention, which features projector 200 for illuminating a three-dimensional object 402 with coded light and an imager 404 for collecting the reflected coded light from object 402. The patterns projected by projector 200 are shown as projected patterns 406; a scanning range 408 is also indicated by the labeled shape outlined by dotted lines.

As previously described, the operation of the micro-mirror or micro-minors within projector 200 needs to be controlled so that suitable patterns are projected in space and time. A suitable degree of precision with regard to the movements of the micro-mirror(s) enables such suitable patterns to be projected. In the non-limiting embodiment shown herein, control is provided through an operating system 410, which performs the necessary calculations regarding the movements of the micro-mirror(s). Operating system 410 receives information regarding the current position of the micro-mirror(s) through a DSP (digital signal processor) 412 and then calculates the next position of the micro-mirror(s) according to the desired pattern to be produced. Determining the actual pattern to be produced and the timing of changes between patterns is well known in the art, and could be determined by anyone skilled in the art of coded light projection. Typically the patterns are gray code, binary codes or some other type of pattern as is known in the art. Operating system 410 then issues one or more commands through DSP 412 regarding one or more movements of the micro-mirror(s) as required.

DSP 412 communicates to an X-modulator 414 and a Y-modulator 416, each of which in turn communicates with a micro-mirror X-control 418 and a micro-mirror Y-control 420, for controlling pivoting of the micro-mirror(s) in the X and Y axes, respectively, for example through an actuator (not shown). Feedback and calibration of the position of the micro-mirror(s) could easily be performed as is known in the art and could be determined by someone of ordinary skill in the art. Optionally, only micro-mirror Y-control 420 is implemented such that only movement along the Y-axis is permitted. In any case DSP 412 provides a signal that allows the mechanism moving the micro-minor to move the micro-minor periodically and scan the array of masks (not shown). For example and without wishing to be limited, the signal from DSP 412 could be a saw-tooth activation signal that causes the minor to periodically and systematically scan a one-dimensional vector of masks or a two-dimensional array of masks.

As shown, DSP 412 communicates with imager 404 for synchronization, while imager 404 in turn provides the image data to DSP 412. Synchronization is optionally achieved through the deformed pattern by which the reconstruction of the image from the image data is performed. Also a synchronization pattern may be used to detect the geometric relation between the imager 404 and the projector 200.

Calibration of the overall imaging system 400 is preferably performed at least once at the start of obtaining image data but may optionally be performed one or more times during the process of obtaining image data. Optionally, one of the patterns of the mask array could be a calibration pattern (which is a bit different than the rest of the patterns) for such an initial and/or intermittent calibration, which may optionally be used to “tune” the above geometric relation and also to set various operational parameters of system 400.

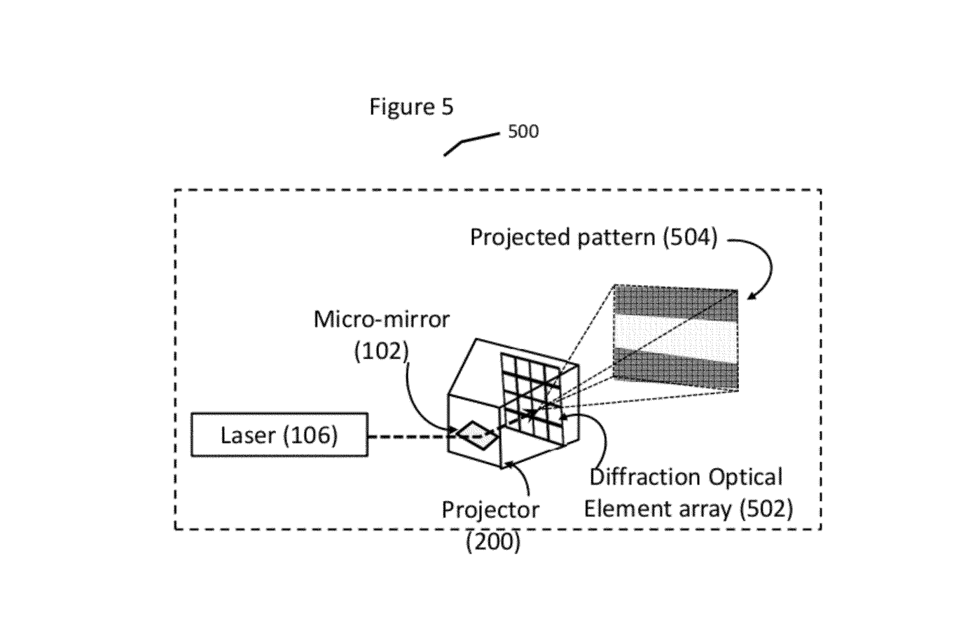

FIG. 5 shows a schematic diagram of an illustrative, exemplary imaging system 500, featuring simplified components from imaging system 400 of FIG. 4 for ease and clarity of illustration and without intending to be limiting in any way. Components with the same or similar function have the same numbers as for FIGS. 1-4.

As shown, projector 200 features a plurality of masks, in this example implemented as a diffraction optical element array 502. A laser beam from laser 106 is reflected by micro-mirror 102; as micro-mirror 102 pivots, the beam illuminates different elements of diffraction optical element array 502, causing a pattern of coded light 504 to be projected. Each element of diffraction optical element array 502 produces a single pattern.

Diffraction optical element array 502 may optionally be combined with non-uniform diffusers and/or refractive optical elements (not shown).

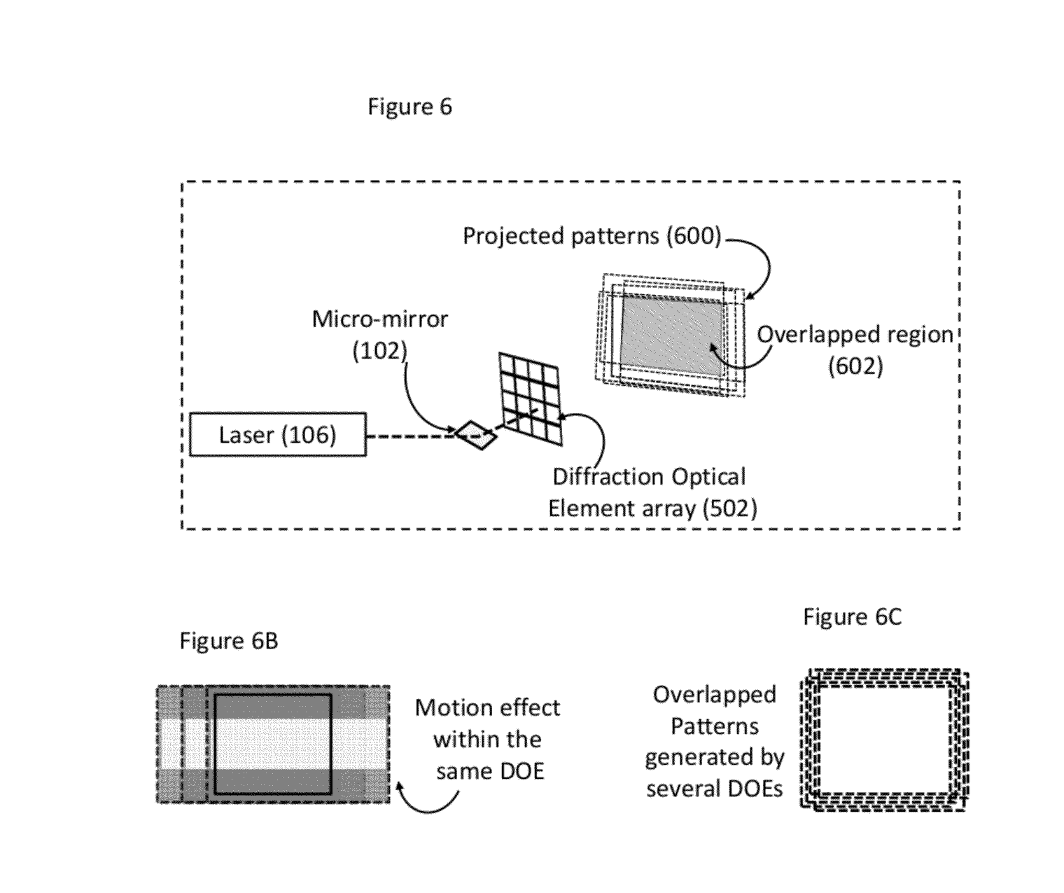

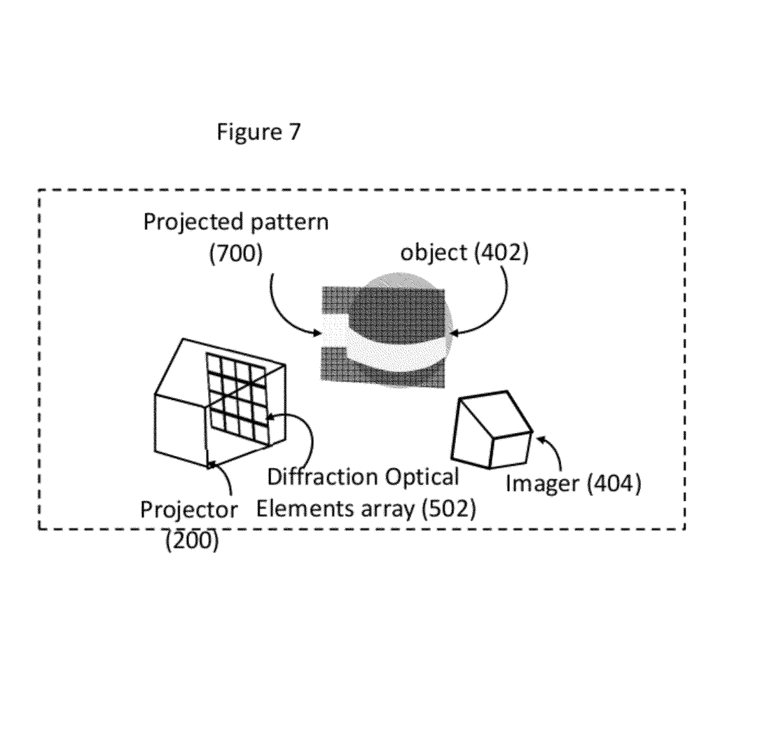

FIGS. 6A-6C and FIG. 7 show the effects of sequentially illuminating a plurality of elements of the diffraction optical element array. Components with the same or similar function have the same numbers as for FIGS. 1-5. FIG. 6A shows imaging system 500 after laser beam has sequentially illuminated a plurality of elements of diffraction optical element array 502, resulting in a plurality of projected patterns 600 having an overlapping region 602. Each element of diffraction optical element array 502 produces a single pattern (as previously described, a mask may optionally comprise a diffraction optical element, such that a mask array may optionally comprise a diffraction optical element array). Pivoting by micro-mirror 102, and hence differential reflection of the laser beam, causes the pattern to be shifted horizontally so that for each element of diffraction optical element array 502, the pattern does not change within the overlapping region 602, as the laser beam illuminates each element of diffraction optical element array 502 with a sufficiently brief duration to stabilize the pattern. FIG. 6B shows the resultant motion effect within the pattern generated by the same element of diffraction optical element array 502, while FIG. 6C shows the overlapped patterns generated by a plurality of elements of diffraction optical element array 502. FIG. 7 shows an exemplary projected pattern 700 on three-dimensional object 402 as viewed by imager 404, as a result of the process outlined in FIGS. 6A-6C.

FIG. 8 relates to an exemplary method according to at least some embodiments of the present invention for performing a process with a system such as that described in FIG. 4 for example. The process is a closed-loop feedback process that generally depends upon an actuator (a mechanism that moves the mirror), a sensor that senses the actual position of the mirror (which may optionally comprise a capacitor and/or optical feedback control as described with regard to U.S. Pat. No. 6,985,271, hereby incorporated by reference as if fully set forth herein), and a controller that receives sensor measurements and controls the actuator to ensure the mirror moves with constant speed. The controller may optionally be part of the operating system described with regard to FIG. 4.

The process does not require any type of measurement regarding the mask array, the location of the masks or the type of mask, as these are known and fixed parameters which are assumed not to change during the process. Specific implementations of such processes for micro-mirrors are known in the art generally, although not for generating structured light (see for example “Closed-loop feedback-control system for improved tracking in magnetically actuated micro-mirrors”, by Pannu et al, pages 107-108, 2000, IEEE/LEOS International Conference on Optical MEMS). Therefore the details provided herein relate specifically to the generation of structured light.

Closed-loop feedback processes for moving micro-mirrors need to respond dynamically to feedback, with a short “settling time” (time to reach the new desired position of the mirror) and rejection of external disturbances. In the case of structured light, the required precision of the feedback process (and the corresponding tolerance for “settling time” and external disturbances) depends at least partially upon the number of masks and their relative location. As the number of masks and their relative density increases, the required precision of the feedback process also increases.

For the purpose of illustration only, the feedback process described in the method of FIG. 8 relates to a PID (proportional integral derivative) method, although any other suitable method could be selected and implemented by one of ordinary skill in the art. In stage 1, the actuator moves the micro-mirror to a new position, for example according to the operation of the previously described system of FIG. 4. In stage 2, the sensor returns one or more measurements of the actual new position of the micro-mirror (by “position” it is meant at least a change in angle of the micro-mirror). In stage 3, three error values are calculated: the proportional, integral and derivative values. In stage 4, each of these error values is examined to determine whether a further change in the micro-mirror position is required. The proportional value relates to the current error, which is the difference between the actual position of the micro-mirror and its desired position. If the proportional error is greater than a certain threshold, then optionally an immediate correction is required. The integral value relates to accumulated error; this value is optionally used to provide feedback to the actuator regarding future changes in the micro-mirror position and also for the current position. However, the derivative, or rate of accumulation of errors, is preferably used to adjust the extent to which the integral value provides feedback regarding previous errors, so as to avoid overshoot. In stage 5, a controller receives feedback, calculated according to stage 4, regarding the change in position of the micro-mirror. Optionally one or more heuristics may also be applied at this stage, for example regarding the optical effect of imprecision of the position of the micro-mirror. In stage 6, the feedback is used by the controller to determine a new command to the actuator, and the method preferably begins again with stage 1.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A projector for projecting coded light, comprising a light source for providing a light beam, a single micro-minor capable of pivoting in two or one axes for reflecting said light beam and a plurality of masks for being illuminated sequentially by said reflected light beam, wherein each mask projects a pattern.

2. A projector for projecting coded light, comprising a light source for providing a light beam, two micro-mirrors each of which is capable of pivoting in a single axis for reflecting said light beam, wherein each axis of each micro-mirror is a different axis, and a plurality of masks for being illuminated sequentially by said reflected light beam, wherein each mask projects a pattern.

3. The projector of claim 1, wherein said light source is a laser source.

4. The projector of claim 3, wherein said laser source emits radiation in the near infra-red spectrum.

5. The projector of claim 1, wherein said plurality of masks comprises a diffraction optical element (DOE) array.

6. The projector of claim 1, wherein said plurality of masks comprises an array of amplitude masks.

7. The projector of claim 1, wherein said plurality of masks comprises an array of non-uniform diffusers.

8. The projector of claim 7, wherein said plurality of masks comprises an array of diffractive optical elements combined with non-uniform diffusers.

9. The projector of claim 1, wherein said plurality of masks comprises an array of diffractive optical elements combined with refractive optical elements.

10. The projector of claim 1, wherein each mask of said plurality of masks comprises an optical element and a one-dimensional mask.

11. The projector of claim 10, wherein said optical element is selected from the group consisting of a cylindrical lens or non-uniform diffuser.

12. The projector of claim 1, wherein said plurality of masks is arranged in a one-dimensional vector.

13. The projector of claim 1, wherein said plurality of masks is arranged in a two-dimensional array.

14. The projector of claim 2, wherein said light source is a laser source.

15. The projector of claim 14, wherein said laser source emits radiation in the near infra-red spectrum.

16. An imaging system, comprising a projector according to claim 1 and an imager.

17. The system of claim 16, further comprising an operating system for controlling said micro-mirror(s).

18. The system of claim 17, further comprising an actuator for positioning the micro-mirror(s) and a sensor for sensing a position of a micro-mirror, and wherein said operating system further comprises a controller for receiving one or more measurements from said sensor and for controlling said actuator according to feedback from said one or more measurements.

19. A method for providing structured light, comprising providing the system of claim 18; positioning the micro-mirror(s) by said actuator; sensing a position of a micro-mirror by said sensor; determining an error in said measurements from said sensor; and adjusting said actuator according to said error.

20. The method of claim 19, wherein said determining said error comprises determining at least a proportional error, optionally adjusted according to one or both of integral or derivative error; and wherein said adjusting said actuator comprises determining a position of said micro-mirror at least partially according to said determined error.
